(19) United States
(12) Patent Application Publication
(10) Pub. No.: US 2011/0198980 A1
(43) Pub. Date: Aug. 18, 2011

(54) PLASMA DISPLAY APPARATUS

(76) Inventor: Jeong Seob SHIM, Gumi-si (KR)

(21) Appl. No.: 12/444,943

(22) PCT Filed: Oct. 12, 2007
(86) PCT No.: PCT/KR07/04999

§ 371 Date: Jun. 14, 2010

(30) Foreign Application Priority Data
Oct. 12, 2006 (KR) 1020060099481

(51) Int. Cl. H01J 61/40

(52) U.S. Cl. 313/112

(57) ABSTRACT

The present invention relates to a plasma display apparatus. The plasma display apparatus includes a plasma display panel, a filter disposed on a front surface of the panel and comprising at least one of an anti-reflection (AR) layer, a near infrared (NIR)-shielding layer, and an electromagnetic interference (EMI)-shielding layer, and an external light-shielding sheet disposed on the front surface of the panel and comprising a base unit and a plurality of pattern units formed in the base unit. The filter and the external light-shielding sheet are adhered to the panel or fixed to a supporter. An air layer exists between the external light-shielding sheet and the filter. According to the present invention, a black image can be implemented effectively and bright room contrast can be improved. Further, a Moire effect can be reduced effectively and a ghost phenomenon can be improved.

### TECHNICAL FIELD

The present invention relates to a plasma display apparatus, and more particularly, to a plasma display apparatus in which an external light-shielding sheet for shielding light incident from the outside of a plasma display panel is disposed on a front surface of the panel, improving bright room contrast of the panel and maintaining the luminance of the panel.

### BACKGROUND ART

In general, a plasma display panel is configured to generate a discharge by applying a voltage to electrodes disposed in the discharge spaces and display images, including characters and/or graphics, by exciting phosphors with a plasma generated during the discharge of gas. The plasma display panel is advantageous in that it can be made large, light, and flat and thin, and can provide a wide viewing angle in all directions and can be implemented with full colors and high luminance.

### DISCLOSURE OF INVENTION

### Technical Problem

In the plasma display panel constructed above, when a black image is implemented, external light is reflected from a front surface of the panel due to white-based phosphors exposed to a lower plate of the panel. Accordingly, the conventional panel is problematic in that contrast is lowered since the black image is recognized as a bright-based dark color.

### Technical Solution

Accordingly, the present invention is directed to provide a plasma display apparatus, which is able to improve bright room contrast and luminance of a plasma display panel and reduce the Moire effect by effectively shielding external light incident on the panel.

In an aspect, a plasma display apparatus according to the present invention includes a plasma display panel, a filter disposed on a front surface of the panel and comprising at least one of an anti-reflection (AR) layer, a near infrared (NIR)-shielding layer, and an electromagnetic interference (EMI)-shielding layer, and an external light-shielding sheet disposed on the front surface of the panel and comprising a base unit and a plurality of pattern units formed in the base unit. The filter and the external light-shielding sheet are adhered to the panel or fixed to a supporter. An air layer exists between the external light-shielding sheet and the filter.

In another aspect, a plasma display apparatus according to the present invention includes a plasma display panel, a filter comprising at least one of an AR layer, a NIR-shielding layer, and an EMI-shielding layer, and an external light-shielding sheet comprising a base unit and a plurality of pattern units formed in the base unit. The external light-shielding sheet is adhered to a front surface of the panel, the filter is spaced apart from the panel and fixed to a supporter disposed on the front surface of the panel, and an air layer exists between the external light-shielding sheet and the filter.

### Advantageous Effects

According to the present invention, a black image can be implemented effectively and bright room contrast can be improved. Further, a Moire effect can be reduced effectively and a ghost phenomenon can be improved.

### BRIEF DESCRIPTION OF THE DRAWINGS

FIG. 1 is a perspective view illustrating an embodiment of a structure of a plasma display apparatus;

FIG. 2 is a cross-sectional view illustrating an embodiment of a schematic cross section of an external light-shielding sheet;

FIGS. 3 to 6 are cross-sectional views illustrating optical characteristics according to the structure of the external light-shielding sheet;

FIG. 7 is a cross-sectional view illustrating a first embodiment of the shape of a pattern unit of the external light-shielding sheet;

FIG. 8 is a view illustrating an embodiment of a front surface shape of pattern units formed in a row in the external light-shielding sheet;

FIG. 9 is a cross-sectional view schematically illustrating a first embodiment of a structure of a plasma display apparatus in which a filter and an external light-shielding sheet are disposed on a front surface of a plasma display panel according to the present invention;

FIG. 10 is a cross-sectional view illustrating an embodiment of a structure of the filter disposed on a front surface of the plasma display panel;

FIG. 11 is a cross-sectional view schematically illustrating a second embodiment of a structure of a plasma display apparatus in which a filter and an external light-shielding sheet are disposed on a front surface of a plasma display panel according to the present invention;

FIG. 12 is a cross-sectional view schematically illustrating a third embodiment of a structure of a plasma display apparatus in which a filter and an external light-shielding sheet are disposed on a front surface of a plasma display panel according to the present invention;

FIG. 13 is a cross-sectional view schematically illustrating a fourth embodiment of a structure of a plasma display apparatus in which a filter and an external light-shielding sheet are disposed on a front surface of a plasma display panel according to the present invention;

FIGS. 14 and 15 are cross-sectional views illustrating whether a ghost phenomenon according to a distance between the plasma display panel and the external light-shielding sheet has occurred;

FIGS. 16 and 17 are views illustrating embodiments of a structure of an EMI-shielding sheet and an external light-shielding sheet;

FIGS. 18 to 23 are cross-sectional views illustrating second and seventh embodiments of the shape of a pattern unit of the external light-shielding sheet; and

FIG. 24 is a cross-sectional view illustrating a relationship between the distance between neighboring pattern units formed in the external light-shielding sheet and the height of the pattern unit.

### BEST MODE FOR CARRYING OUT THE INVENTION

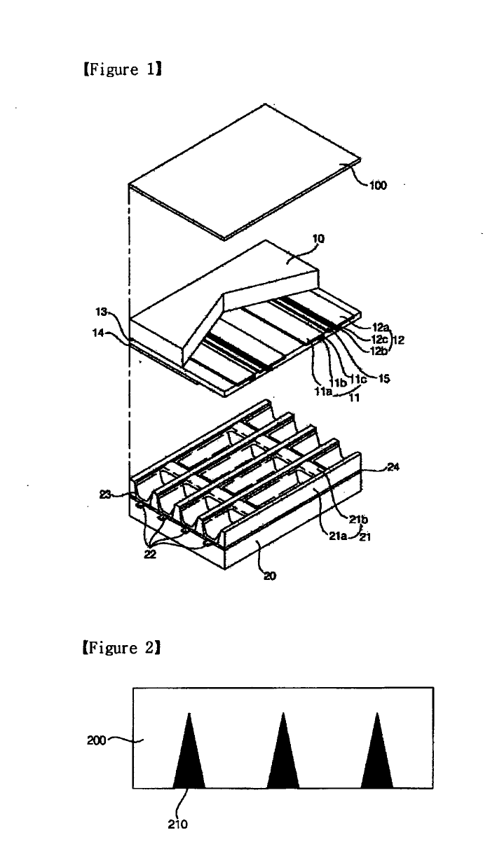

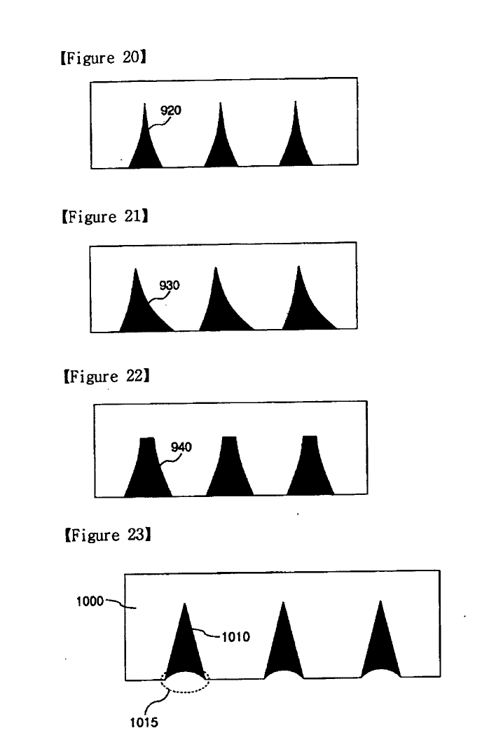

The present invention will now be described in detail in connection with specific embodiments with reference to FIGS. 1 to 24. FIG. 1 is a perspective view illustrating an embodiment of a structure of a plasma display apparatus.

Referring to FIG. 1, the plasma display panel includes a scan electrode 11 and a sustain electrode 12 (that is, a sustain electrode pair), which are formed on a front substrate 10, and address electrodes 22 formed on a rear substrate 20.

The sustain electrode pair 11 and 12 includes transparent electrodes 11a and 12a, which are generally formed from indium-tin-oxide (ITO), and bus electrodes 11b and 12b. The bus electrodes 11b and 12b may be formed from metal, such as silver (Ag) or chrome (Cr), a stack type of Cr/copper (Cu)/Cr or Cr/aluminum (Al)/Cr. The bus electrodes 11b and 12b are formed on the transparent electrodes 11a and 12a, and serve to reduce a voltage drop caused by the transparent electrodes 11a and 12a with a high resistance.

According to an embodiment of the present invention, the sustain electrode pair 11 and 12 may include only the bus electrodes 11b and 12b without the transparent electrodes 11a and 12a as well as the stack structure of the transparent electrodes 11a and 12a and the bus electrodes 11b and 12b. This structure is advantageous in that it can save the manufacturing cost of the panel because it does not use the transparent electrodes 11a and 12a. The bus electrodes 11b and 12b used in the structure may also be formed by using a variety of materials, such as a photosensitive material, other than the above materials.

Black matrices 15 may be arranged between the transparent electrodes 11a and 12a and the bus electrodes 11b and 12b of the scan electrode 11 and the sustain electrode 12. The black matrix 15 has a light-shielding function of absorbing external light generated outside the front substrate 10 and reducing reflection of the light and a function of improving the purity and contrast of the front substrate 10.

The black matrix according to an embodiment of the present invention is formed in the front substrate 10. The black matrix 15 may include a first black matrix 15 formed at a location where it is overlapped with a barrier rib 21, and second black matrices 11c and 12c formed between the transparent electrodes 11a and 12a and the bus electrodes 11b and 12b. The first black matrix 15, and the second black matrices 11c and 12c, which are also referred to as a black layer or a black electrode layer, may be formed at the same time and thus connected physically, or may not be formed at the same time and not be thus connected physically.

In the event that the first black matrix 15 and the second black matrices 11c and 12c are connected to each other physically, the first black matrix 15 and the second black matrices 11c and 12c may be formed by using the same material. However, in the event that the first black matrix 15 and the second black matrices 11c and 12c are not connected to each other physically, they may be formed by using different materials.

Since the bus electrodes 11b and 12b or the barrier rib 21 has dark color, it may also have a light-shielding function of absorbing external light and reducing reflection of the light and a function of improving contrast, such as those of the black matrix. Further, a specific member formed in the front substrate 10 (for example, the dielectric layer 13) and a specific member formed in and the rear substrate 20 (for example, the barrier rib 21) mutually have a complementary color relationship. Accordingly, the overlapping portion looks close to dark color when viewed from the front side of the panel, so that the barrier rib 21 may have the same functions as those of the black matrix.

An upper dielectric layer 13 and a protection layer 14 are laminated over the front substrate 10 in which the scan electrodes 11 and the sustain electrodes 12 are formed in parallel. Charged particles generated by a discharge are accumulated on the upper dielectric layer 13, and the upper dielectric layer 13 and the protection layer 14 may function to protect the sustain electrode pair 11 and 12. The protection layer 14 functions to protect the upper dielectric layer 13 from the sputtering of charged particles generated during the discharge of a gas and also increase emission efficiency of secondary electrons.

The address electrodes 22 are formed to cross the scan electrodes 11 and the sustain electrodes 12. A lower dielectric layer 24 and the barrier ribs 21 are formed over the rear substrate 20 in which the address electrodes 22 are formed.

Phosphor layers 23 are formed on the surfaces of the lower dielectric layer 24 and the barrier ribs 21. Each of the barrier ribs 21 includes a longitudinal barrier rib 21a and a traverse barrier rib 21b, which have a closed type. The barrier ribs 21 partition discharge cells physically, and can prevent ultraviolet rays, generated by a discharge, and a visible ray from leaking to neighboring discharge cells.

Referring to FIG. 1, a filter 100 may be preferably formed on a front surface of the plasma display panel according to an embodiment of the present invention. The filter 100 may include an anti-reflection (AR) sheet, a near infrared (NIR) shielding sheet, an electromagnetic interference (EMI)-shielding sheet, an optical characteristic sheet and so on.

When a distance between the filter 100 and the panel ranges from 10 to 30 μm, externally incident light can be shielded effectively, and light generated from the panel can be effectively emitted to the outside. In order to protect the panel from external pressure, etc., the distance between the filter 100 and the panel may be set in the range of 30 to 120 μm. To prevent shock, an adhesive layer having a function of absorbing shock may be formed between the filter 100 and the panel.

The plasma display apparatus according to the present invention may further include an external light-shielding sheet disposed on the front surface of the panel. The external light-shielding sheet functions to absorb external light incident on the panel from the outside and can therefore improve bright room contrast of a display image.

The filter and the external light-shielding sheet may be formed on the front surface of the filter with them being spaced apart from each other, and an air layer may exist between the filter and the external light-shielding sheet. Further, the filter may be fixed to the external light-shielding sheet, or the filter and the external light-shielding sheet may be fixed by means of an additional supporter and then fixed to a back cover of the plasma display apparatus, for supporting the filter or the panel.

The filter may have a film type structure in which a plurality of function layers are laminated on a base film formed from polyethyleneterephthalate (PET). Alternatively, the filter may have a glass type structure in which a plurality of function layers are laminated on glass. The film type filter may be attached to the front surface of the panel, and the glass type filter may be supported by means of the filter supporter connected to the back cover.

An embodiment of the present invention may be also applied to a barrier rib structure having a variety of shapes as well as the structure of the barrier ribs 21 shown in FIG. 1. For example, the present embodiment may be applied to a differential type barrier rib structure in which the longitudinal barrier rib 21a and the traverse barrier rib 21b have a different height, a channel type barrier rib structure in which a channel, which can be used as an exhaust passage, is formed in one or more of the longitudinal barrier rib 21a and the traverse barrier rib 21b, a hollow type barrier rib structure in which a hollow is formed in one or more of the longitudinal barrier rib 21a and the traverse barrier rib 21b.

In the case of the differential type barrier rib structure, the traverse barrier rib 21b may preferably have a higher height. In the case of the channel type barrier rib structure or the hollow type barrier rib structure, the channel or hollow may be preferably formed in the traverse barrier rib 21b.

Meanwhile, in the present embodiment, it has been described that the red (R), green (G), and blue (B) discharge cells are arranged on the same line. However, the R, G, and B discharge cells may also be arranged in different forms. For example, the R, G, and B discharge cells may have a delta type arrangement of a triangle. Alternatively, the discharge cells may be arranged to have a variety of forms, such as square, pentagon and hexagon.

Further, the phosphor layer 23 is excited with ultraviolet rays generated during the discharge of gas, and generates a visible ray of one of R, G, and B. The discharge space partitioned between the front/rear substrates 10 and 20 and the barrier ribs 21 are filled with an inert mixed gas for a discharge, such as He+Xe, Ne+Xe or He+Ne+Xe.

FIG. 2 is a cross-sectional view illustrating an embodiment of a schematic cross section of the external light-shielding sheet. The external light-shielding sheet includes a base unit 200 and pattern units 210.

The base unit 200 may be formed of a transparent plastic material (for example, a resin-based material formed by means of a UV-hardening method) through which light can pass easily. In order to increase an effect of protecting the front surface of the panel, the base unit 200 may be formed of a robust glass material.

Referring to FIG. 2, each pattern unit 210 may have a triangle or other various shapes. The pattern unit 210 may be formed of a material darker than that of the base unit 200, preferably a dark material. For example, the pattern unit 210 may be formed of a carbon-based material or may be coated with dark dyes in order to increase the external light absorption effect. Hereinafter, it is assumed that one of a top surface and a bottom surface of the pattern unit 210, which has a wider width, is the bottom surface of the pattern unit 210.

In FIG. 2, the bottom surface of the pattern unit 210 may be disposed on the panel side, and the top surface of the pattern unit 210 may be disposed on the viewer side on which external light is incident. Alternatively, the bottom surface of the pattern unit 210 may be disposed on the viewer side, and the top surface of the pattern unit 210 may be disposed on the panel side.

An external light source is generally disposed over the panel. Thus, external light is slantly incident on the panel from an upper side and thus absorbed by the pattern units 210.

The pattern unit 210 may include light absorption particles. The light absorption particles may include resin particles colored with a specific color. In order to maximize a light absorption effect, the light absorption particles may be colored with dark color.

In order to facilitate the fabrication of light absorption particles and the addition of light absorption particles to the pattern units 210, and maximize the effect of absorbing external light, the light absorption particle may have a size of 1 μm or more. When the size of the light absorption particle is 1 μm or more, the pattern unit 210 may comprise a light absorption particle of 10 weight % or more in order to effectively absorb external light refracted to the pattern unit 210. In other words, a light absorption particle of 10% or more of a total weight of the pattern unit 210 may be included in the pattern unit 210.

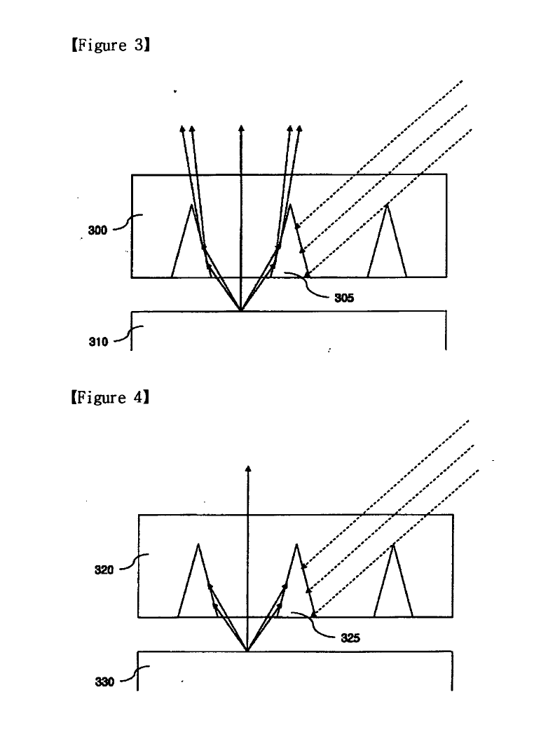

FIGS. 3 to 6 are cross-sectional views illustrating embodiments of the structure of the external light-shielding sheet in order to describe an optical characteristic according to the structure of the external light-shielding sheet.

In FIG. 3, in order to absorb and shield external light and increase the reflectance of panel light through total reflection of a visible ray emitted from the panel, a reflective index of a pattern unit 305 (that is, a reflective index of an inclined surface (i.e., at least a part) of the pattern unit 305 is set lower than that of the base unit 300.

External light that degrades bright room contrast of the plasma display panel as described above is usually placed over the panel. Referring to FIG. 3, external light (indicated by a dotted line), which is incident on an external light-shielding sheet, is refracted to the pattern unit 305 having a reflective index lower than that of the base unit 300 and is thus absorbed in accordance with Snell's law. The external light refracted into the pattern units 310 can be absorbed by optical absorbing particles.

For a display purpose, light (indicated by a solid line), which is emitted from a panel 310 to the outside is totally reflected from the inclined surface of the pattern unit 305 and is then reflected toward the outside (that is, the viewer side).

The reason why the external light (indicated by a dotted line) is refracted to and absorbed by the pattern unit 305 and the light (indicated by a solid line) emitted from the panel 310 is totally reflected from the pattern unit 305, as described above, is that an angle in which the external light and the inclined surface of the pattern unit 305 form is larger than an angle in which the panel light and the inclined surface of the pattern unit 305 form.

Thus, the external light-shielding sheet according to the present invention absorbs external light so that it is reflected toward the viewer side and increases the reflection amount of light emitted from the panel 310, so that bright room contrast of a display image can be improved.

In order to maximize the absorption of external light and total reflection of the panel (310) light in consideration of an angle of the external light incident on the panel 310, the reflective index of the pattern unit 305 may be 0.3 to 1 times less than that of the base unit 300. In order to maximize total reflection of light, which is emitted from the panel 310, from the inclined surface of the pattern unit 305, the reflective index of the pattern unit 305 may be 0.3 to 0.8 times greater than that of the base unit 300 when considering upper and lower viewing angles of the plasma display panel.

In the event that a top surface of the pattern unit 305 is disposed on the viewer side and the refractive index of the pattern unit 305 is lower than that of the base unit 300 as shown in FIG. 3, light emitted from the panel is reflected from the inclined surface of the pattern unit 305 and spreads to the viewer side. Accordingly, a ghost phenomenon in which an image looks not clear and scattered when viewed from the viewer side may occur.

FIG. 4 illustrates a case where a top surface of a pattern unit 325 is disposed on the viewer side and the refractive index of the pattern unit 325 is higher than that of a base unit 320. Referring to FIG. 4, since the refractive index of the pattern unit 325 is higher than the refractive index of the base unit 320, both external light and panel light incident on the pattern unit 325 are absorbed by the pattern unit 325 in accordance with Snell's law.

If the top surface of the pattern unit 325 is disposed on the viewer side and the refractive index of the pattern unit 325 is higher than the refractive index of the base unit 320 as described above, a ghost phenomenon can be reduced. In order to sufficiently absorb panel light slantly incident on the pattern unit 325 and prevent a ghost phenomenon, a difference between the refractive index of the pattern unit 325 and the refractive index of the base unit 320 may be set to 0.05 or more.

If the refractive index of the pattern unit 325 is higher than the refractive index of the base unit 320, the transmittance of an external light-shielding sheet and bright room contrast can be reduced. In order to prevent a ghost phenomenon and also not greatly lower the transmittance of the external light-shielding sheet, a difference between the refractive index of the pattern unit 325 and the refractive index of the base unit 320 may be in the range of 0.05 to 0.3. Further, in order to prevent a ghost phenomenon and maintain bright room contrast of the panel to an appropriate level, the refractive index of the pattern unit 325 may be 1.0 to 1.3 times higher than that of the base unit 320.

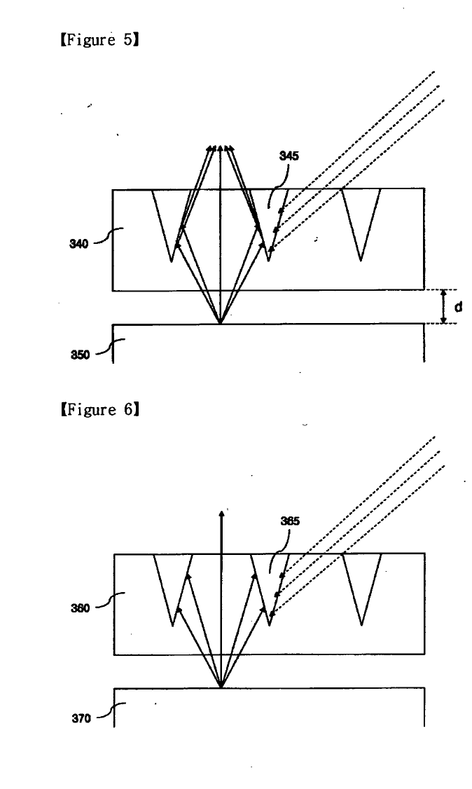

FIG. 5 illustrates a case where a bottom surface of a pattern unit 345 is disposed on the viewer side and the refractive index of the pattern unit 345 is lower than that of a base unit 340. Referring to FIG. 5, the bottom surface of the pattern unit 345 is disposed on the viewer side on which external light is incident so that external light is absorbed by the bottom surface of the pattern unit 345. Accordingly, an external light-shielding effect can be improved. Further, a distance between the bottom surfaces of the pattern units 345 can be made large when compared with the case of FIG. 4, so that the aperture ratio of an external light-shielding sheet can be improved.

As shown in FIG. 5, panel light emitted from a panel 350 can be reflected from an inclined surface of the pattern unit 345 and then gathers at the center through the base unit 340. Accordingly, a ghost phenomenon can be reduced while not significantly lowering the transmittance of an external light-shielding sheet.

As panel light is reflected from the inclined surface of the pattern unit 345 and then gathers at the center through the base unit 340, a distance d between the panel 350 and the external light-shielding sheet may be set to 1.5 to 3.5 mm in order to prevent a ghost phenomenon.

FIG. 6 illustrates a case where a bottom surface of a pattern unit 365 is disposed on the viewer side and the refractive index of the pattern unit 365 is higher than that of a base unit 360. Referring to FIG. 6, since the refractive index of the pattern unit 365 is higher than that of the base unit 360, panel light incident on an inclined surface of the pattern unit 365 can be absorbed by the pattern unit 365. Accordingly, an image is displayed by the panel light passing through the base unit 360, so that a ghost phenomenon can be reduced.

Further, since the refractive index of the pattern unit 365 is higher than that of the base unit 360, an external light absorption effect can be improved.

FIG. 7 is a cross-sectional view illustrating a first embodiment of the shape of the pattern unit of the external light-shielding sheet.

When an external light-shielding sheet has a thickness T of 20 to 250 μm, a fabrication process can be convenient and an adequate optical transmittance can be obtained. The thickness T of the external light-shielding sheet may be set in the range of 100 to 180 μm so that light emitted from the panel smoothly transmits through the external light-shielding sheet, externally incident light is refracted to and effectively absorbed and shielded by a pattern unit 410, and the robustness of the sheet can be secure.

Referring to FIG. 7, the pattern unit 410 formed on a base unit 400 may have a triangle, more preferably, an isosceles triangle. The pattern unit 410 may have a bottom width P1 of 18 to 35 μm. In this case, the aperture ratio for allowing light generated from the panel to be smoothly emitted to a user side can be secured, and external light-shielding efficiency can be maximized.

The pattern unit 410 may have a height h of 80 to 170 μm. It is thus possible to form an inclined surface slope, which is able to effectively absorb external light and effectively reflect panel light in a relationship with the bottom width P1, and also to prevent the short of the pattern unit 410.

In order to emit the panel light toward a user and secure an aperture ratio for displaying a display image having an adequate luminance and to secure an optimal inclined surface slope of the pattern unit 410 for increasing an external light-shielding effect and panel light reflection efficiency, a distance D1 between two neighboring pattern units may be set in the range of 40 to 90 μm, and a distance D2 between top surfaces of two neighboring pattern units may be set in the range of 90 to 130 μm.

For the above reasons, when the distance D1 between two neighboring pattern units is 1.1 to 5 times greater than the bottom width of the pattern unit 410, an aperture ratio for display can be secured. Further, in order to optimize an external light-shielding effect and panel light reflection efficiency while securing an aperture ratio, the distance D1 between two neighboring pattern units may be set in the range of 1.5 to 3.5 times greater than the bottom width of the pattern unit 410.

When the height h of the pattern unit 410 is 0.89 to 4.25 times greater than the distance D1 between two neighboring pattern units, external light slantly incident from an upper side can be prevented from being incident on the panel. Further, in order to prevent the short of the pattern unit 410 and optimize reflection efficiency of the panel light, the height h of the pattern unit 410 may be range from 1.5 to 3 times greater than the distance D1 between two neighboring pattern units.

When the distance D2 between top surfaces of the two neighboring pattern units is 1 to 3.25 times greater than the distance D1 between bottom surfaces of the two neighboring pattern units, an aperture ratio for displaying an image having an adequate luminance can be secured. Further, in order to optimize reflection efficiency in which the panel light is totally reflected from the inclined surface of the pattern unit 410, the distance D2 between the top surfaces of the two neighboring pattern units may range from 1.2 to 2.5 times greater than the distance D1 between the bottom surfaces of the two neighboring pattern units.

The structure of the external light-shielding sheet according to the present invention has been described above by taking the case where the top surface of the pattern unit 410 is disposed on the viewer side as an example. However, the description presented with reference to FIG. 7 may also be applied to a case where the bottom surface of the pattern unit 410 is disposed on the viewer side.

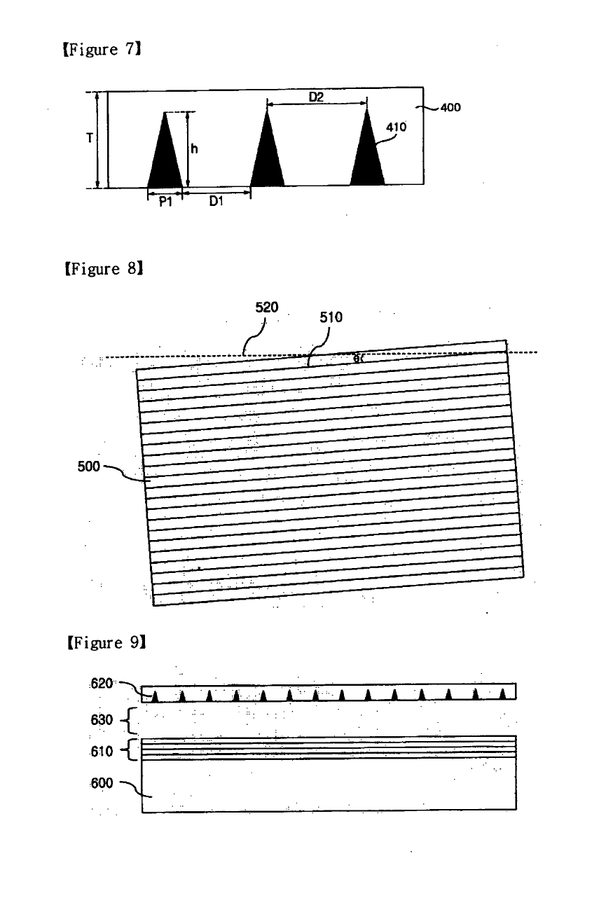

FIG. 8 is a view illustrating an embodiment of a front surface shape of pattern units formed in a row in the external light-shielding sheet. As shown in FIG. 8, a plurality of pattern units 510 of an external light-shielding sheet 500 may be formed in a row on a base unit with them being spaced apart from one another at predetermined distances.

As the plurality of pattern units 510 formed in the external light-shielding sheet 500 at predetermined distances are overlapped with a black matrix, a black layer, bus electrodes, barrier ribs and so on which are formed over a panel in a predetermined pattern, a Moire effect may occur. The Moire effect refers to patterns of a low frequency, which occur as patterns of a similar lattice shape are overlapped. For example, the patterns may include a wave pattern appearing when mosquito nets are overlapped.

Since the pattern unit 510 of the external light-shielding sheet 500 is formed slantly, the Moire effect, which occurs as the pattern unit 510 is overlapped with the black matrix, the black layer, the bus electrodes, the barrier ribs, etc., which are formed in the panel, can be reduced. For example, as shown in FIG. 8, the external light-shielding sheet 500 in which the plurality of panel units 510 are formed in a row is inclined, the occurrence of the Moire effect can be reduced.

In FIG. 8, a direction 520 (indicated by a dotted line) designates a horizontal direction along which the scan or sustain electrodes formed in the front substrate of the panel are formed, and θ designates a dihedral angle formed by the scan or sustain electrodes formed in the front substrate of the panel and the pattern units 510 of the external light-shielding sheet.

Referring to FIG. 8, when the dihedral angle θ formed by the pattern units 510 of the external light-shielding sheet 500 and the electrodes formed in the front substrate of the panel is 20 degrees or less, a Moire effect occurring between the pattern unit 510 and structures formed in a row in the panel can be reduced. Further, when considering that external light incident on the panel is generally located over a user's head, when the dihedral angle θ formed by the pattern units 510 and the electrodes formed in the front substrate of the panel is 5 degrees or less, a Moire effect can be prevented, an appropriate aperture ratio can be secured, reflection efficiency of the panel light can be increased, and external light can be shielded most effectively.

In FIG. 8, it has been shown that the pattern units 510 are inclined from a right lower direction to a left upper direction. Alternatively, the external light-shielding sheet 500 may be inclined such that the pattern units 510 have the above angle from a left upper direction to a right lower direction.

FIG. 9 is a cross-sectional view schematically illustrating a first embodiment of a structure of a plasma display apparatus in which a filter and an external light-shielding sheet are disposed on a front surface of a plasma display panel according to the present invention.

Referring to FIG. 9, a filter 610 in which a plurality of function layers, such as an AR layer, a NIR-shielding layer, and an EMI-shielding layer, are laminated, and an external light-shielding sheet 620 are formed over a front surface of a panel 600.

The filter 610 having the stack structure of the plurality of function layers may be attached to the panel 600. In this case, the filter may include a film type filter in which a plurality of function layers are laminated on a base film made of PET or the like.

The external light-shielding sheet 620, including a plurality of pattern units for absorbing external light, may be disposed over the front surface of the panel 600 with it being spaced apart from the filter 610. The external light-shielding sheet 620 and the filter 610 are spaced apart from each other. To this end, an air layer 630 may be intervened between the external light-shielding sheet 620 and the filter 610.

Since the external light-shielding sheet 620 and the filter 610 are separated from each other and formed over the front surface of the panel 600 as described above, the task of inclining and forming the external light-shielding sheet 620 in order to reduce the Moire effect as described above with reference to FIG. 8 can be facilitated.

The inclined angle of the external light-shielding sheet 620 for the purpose of Moire effect reduction may differ because slight deviation may occur every plasma display apparatus. After the filter 610 separated from the external light-shielding sheet 600 is formed over the front surface of the panel 600, an optimal value of the inclined angle of the external light-shielding sheet 620 for the purpose of Moire effect reduction can be obtained easily. The external light-shielding sheet 620 that is inclined at the above optimal angle may be fixed to the plasma display apparatus by means of an additional supporter.

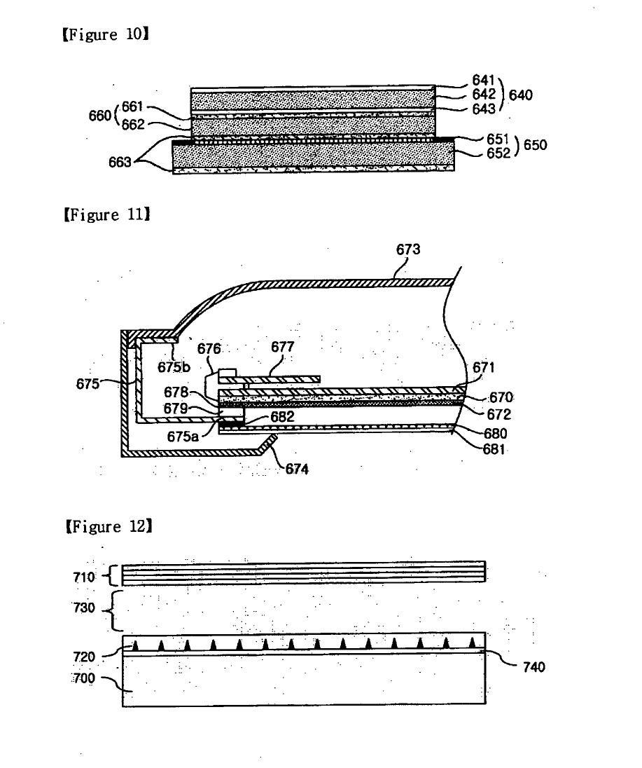

FIG. 10 is a cross-sectional view illustrating an embodiment of a structure of a filter disposed on a front surface of a plasma display panel. The filter may include an AR/NIR sheet 640, an EMI-shielding sheet 650, an optical characteristic sheet 660 and so on.

Referring to FIG. 10, the AR/NIR sheet 640 includes a base sheet 642 formed of a transparent plastic material, an AR layer 641 disposed on a front surface of the base sheet 642 and configured to prevent reflection of externally incident light and reduce a blinding phenomenon, and a NIR-shielding sheet 643 disposed on a rear surface of the base sheet 642 and configured to shield NIR radiated from the panel and cause signals, which are transferred by employing infrared such as a remote controller, to be transferred normally.

The EMI-shielding sheet 650 includes a base sheet 652 formed of a transparent plastic material, and an EMI-shielding layer 651 disposed on a front surface of the base sheet 652 and configured to shield EMI and prevent, EMI radiated from the panel, from being emitted externally. In general, the EMI-shielding layer 651 is formed by using a conductive material and has a mesh structure, and a conductive material is entirely coated on an invalid display region of the EMI-shielding sheet 650 on which images are not displayed in order to facilitate ground.

The optical characteristic sheet 660 functions to improve color temperature and luminance characteristics of light incident from the panel. An optical characteristic layer 661, made of dyes and an adhesive, is laminated on a front or rear surface of a base sheet 662 made of a transparent plastic material.

Adhesive layers 663 may be formed between the AR/NIR sheet 640, the EMI-shielding sheet 650, and the optical characteristic sheet 660. Accordingly, the sheets 640, 650, and 660 and the filter in which the sheets are laminated can be firmly adhered to the front surface of the panel. Further, a material of the base sheets included between the sheets 640, 650, and 660 may include substantially the same material in consideration of the easiness of filter fabrication.

Although the AR/NIR sheet 640, the optical characteristic sheet 660, and the EMI-shielding sheet 650 are sequentially laminated in FIG. 10, the lamination sequence of the plurality of sheets may be changed by those having ordinary skill in the art. Further, at least one of the sheets 640, 650, and 660 may be omitted.

Further, one of the base sheets may be formed of glass instead of the plastic material in order to improve the function of protecting the panel.

The filter according to the present invention may further include a diffusion sheet. The diffusion sheet functions to diffuse incident light in order for the light to maintain a uniform brightness. Thus, the diffusion sheet can diffuse light emitted from the panel uniformly, so that upper and lower viewing angles of a display screen can be widened and patterns formed in an external light-shielding sheet, etc. can be concealed. The diffusion sheet functions to condense light in a direction corresponding to the upper and lower viewing angles, thus making uniform and improving luminance at the front and also improving charging prevention properties.

The diffusion sheet may include a transmission type diffusion film, a reflection type diffusion film or the like. In general, the diffusion sheet may have small glass bead grains mixed in a base sheet made of a polymer material. The base sheet of the diffusion sheet may be formed of a high purity acrylic resin, such as polymethyl methacrylate (PMMA). In the case where PMMA is used, the thickness of the sheet is thick, but has a good heat-resistant property, so that it can be used for large-sized display apparatuses that generate a lot of heat.

FIG. 11 is a cross-sectional view schematically illustrating a second embodiment of a structure of a plasma display apparatus in which a filter and an external light-shielding sheet are disposed on a front surface of a plasma display panel according to the present invention.

Referring to FIG. 11, a heat-dissipation plate 671 is disposed on a rear surface of a panel 670 and functions to dissipate heat generated from the panel 670. A filter 672 includes a plurality of function layers and may be adhered to a front surface of the panel 670. The filter 672 may have a film type filter in which the plurality of function layers are laminated on a base film formed from PET or the like.

A printed circuit board (hereinafter, referred to as a “PCB”) 677 for driving the panel 670 is disposed on the rear surface of the heat-dissipation plate 671. The PCB 677 is fixed to the heat-dissipation plate 671.

To the panel 670 are connected to a number of drive integrated circuit (hereinafter, referred to as an “IC”) for supplying driving signals to the PCB 677. The PCB 677 and the panel 670 may be connected by means of a flexible printed circuit (hereinafter, referred to as a “FPC”) 676.

As shown in FIG. 11, a back cover 673 is spaced apart from the panel 670 at a predetermined distance and disposed at the rear of the panel 670. The filter 672 may be disposed between a filter supporter 675, connected to the back cover 673, and the panel 670. One side 675b of the filter supporter 675 is connected to the back cover 673 and the other side 675a thereof supports the filter 672. A copper sheet 678 for inducing electromagnetic waves, shielded by the filter 672, toward the back cover 673, and an EMI ground unit 679 made of metal may be disposed between the other side 675a of the filter supporter 675 and the filter 672.

In more detail, the copper sheet 678 for inducing EMI is formed at the edge of the filter 672. The EMI ground unit 679 is brought in contact with the copper sheet 678. EMI induced through the copper sheet 678 and the EMI ground unit 679 is induced to the back cover 673 through the filter supporter 675.

As described above, the external light-shielding sheet 680 is spaced apart from the filter 672, and an air layer may be disposed between the external light-shielding sheet 680 and the filter 672.

The external light-shielding sheet 680 may be formed on a base sheet 681. The base sheet 681 is made of PET, glass or the like and functions to improve the strength of the external light-shielding sheet 680.

The back cover 673 is adapted to surround the rear surface of the panel 670. A bezel 674 assembled with the back cover 673 is projected from the front surface of the apparatus and functions to support the external light-shielding sheet 680 while surrounding a part of the edge of the external light-shielding sheet 680.

An adhesive layer 682 is formed between the external light-shielding sheet 680 and the other side 675a of the filter supporter 675, and can fix the external light-shielding sheet 680 to the filter supporter 675. As described above, an optimal angle of the slope of the external light-shielding sheet 680 is obtained in order to reduce a Moire effect and the external light-shielding sheet 680 is fixed by means of the adhesive layer 682 formed on the other side 675a of the filter supporter 675. Accordingly, the Moire effect occurring from the plasma display apparatus can be reduced effectively.

The structure of the plasma display apparatus shown in FIG. 11 is only an embodiment of the structure of the plasma display apparatus according to the present invention. Thus, the plasma display apparatus according to the present invention may have a variety of structures in which the filter is adhered on the front surface of the panel and the external light-shielding sheet is spaced apart from the filter and disposed on the front surface of the panel as well as the structure shown in FIG. 11.

FIG. 12 is a cross-sectional view schematically illustrating a third embodiment of a structure of a plasma display apparatus in which a filter and an external light-shielding sheet are disposed on a front surface of a plasma display panel according to the present invention.

Referring to FIG. 12, an external light-shielding sheet 720 is adhered to a front surface of a panel 700. A filter 710 in which a plurality of function layers are laminated may be disposed over the front surface of the panel 700 with it being spaced apart from the external light-shielding sheet 720. The external light-shielding sheet 720 and the filter 710 are separated from each other. To this end, an air layer 730 may be formed between the external light-shielding sheet 720 and the filter 710.

An adhesive layer 740 for adhering the external light-shielding sheet 720 thereto may be further formed between the external light-shielding sheet 720 and the panel 700.

As described above, since the external light-shielding sheet 720 and the filter 710 are disposed over the front surface of the panel 700 with them being separated from each other, the task of inclining and forming the external light-shielding sheet 720 in order to reduce a Moire effect can be facilitated as described with reference to FIG. 8.

The filter 710 may have the stack structure of the plurality of function layers, which has been described with reference to FIG. 10. In order to improve a function of protecting the panel 700, etc., the filter 710 may have a glass type filter in which the plurality of function layers are laminated on robust glass.

FIG. 13 is a cross-sectional view schematically illustrating a fourth embodiment of a structure of a plasma display apparatus in which a filter and an external light-shielding sheet are disposed on a front surface of a plasma display panel according to the present invention.

As shown in FIG. 13, a back cover 753 is spaced apart from a panel 750 at a predetermined distance and is disposed at the rear of the panel 750. A bezel 754, connected to the back cover 753, and a filter supporter 755 are configured to surround up and down and support the filter 752. The filter supporter 755 has one side 755b coupled to the back cover 753 and the other side 755a supporting a filter 752. An EMI ground unit 759 for inducing electromagnetic waves, shielded by the filter 752, toward the back cover 753 is formed between the other side 755a of the filter supporter 755 and the filter 752. The filter 752 may have a glass type filter in which the plurality of function layers are laminated on robust glass.

An external light-shielding sheet 760 is adhered on a front surface of the panel 750, and may be spaced apart from the filter 752. An air layer may be formed between the external light-shielding sheet 760 and the filter 752. An adhesive layer (not shown) may be further formed between the external light-shielding sheet 760 and the panel 750 in order to adhere the external light-shielding sheet 760 thereto.

The panel 750 to which the external light-shielding sheet 760 is adhered is supported by means of a filter supporter 755. An adhesive layer 758 for supporting the external light-shielding sheet 760 and the panel 760 may be formed between the panel 750 and the other side 755a of the filter supporter 755.

The structure of the plasma display apparatus shown in FIG. 13 is only an embodiment of the structure of the plasma display apparatus according to the present invention. Thus, the plasma display apparatus according to the present invention may have a variety of structures in which the external light-shielding sheet is adhered on the front surface of the panel, and the filter in which the plurality of function layers are laminated is spaced apart from the external light-shielding sheet and then disposed on the front surface of the panel as well as the structure shown in FIG. 13.

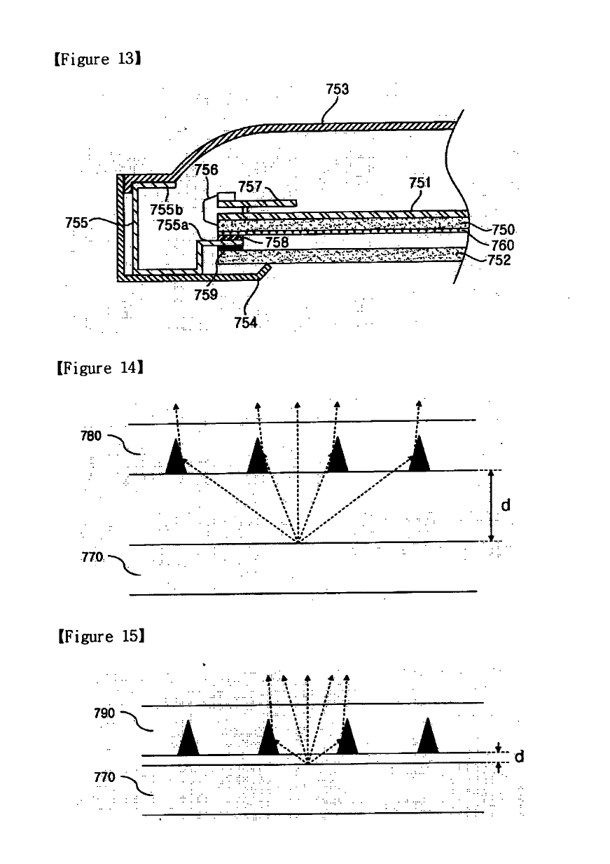

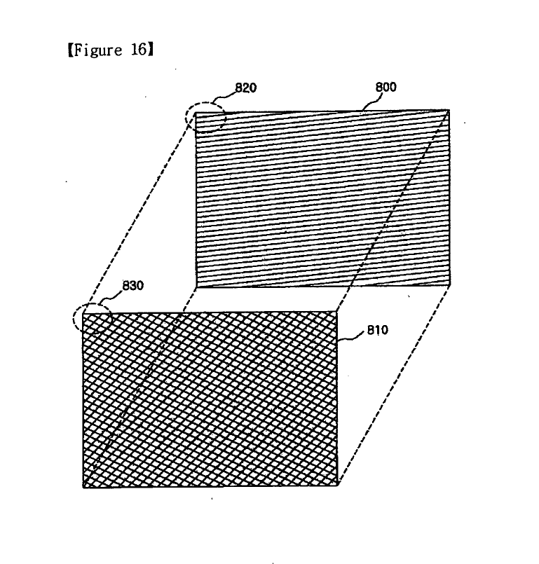

FIGS. 14 and 15 are cross-sectional views illustrating whether a ghost phenomenon according to a distance between the plasma display panel and the external light-shielding sheet has occurred. External light-shielding sheets 780 and 790 are formed on a front surface of a panel 770 with them being spaced apart from each other at a predetermined distanced.

Referring to FIG. 14, a visible ray (indicated by a dotted line), which is emitted from the panel 770, spreads left and right in a predetermined angle range. The emitted visible ray (indicated by a dotted line) is reflected from an inclined surface of pattern units of the external light-shielding sheet and then emitted externally, that is, toward a user side. In this case, since the visible ray is reflected from the pattern units, which are far from a point where the visible ray of the panel is emitted, and then emitted toward a user side as shown in FIG. 14, a ghost phenomenon in which a display image looks spread may occur.

By reducing the distance d between the external light-shielding sheet 790 and the panel 770 as shown in FIG. 15, the visible ray (indicated by a dotted line), which is emitted from the panel 770, can be prevented from being reflected from the inclined surface of the pattern units, which are far from the emission point, so that the above ghost phenomenon can be improved.

For this reason, the external light-shielding sheet 720 is adhered to the panel 700, and the external light-shielding sheet 720 and the filter 710 are spaced apart from each other as shown in FIG. 12. Accordingly, an effect of reducing the Moire effect occurring from the plasma display apparatus can be maximized and the ghost phenomenon can be improved.

FIGS. 16 and 17 are views illustrating embodiments of a structure of an EMI-shielding sheet and an external light-shielding sheet. The drawings show an external light-shielding sheet 800 in which a pattern unit is inclined in order to prevent a Moire effect, and a structure of an EMI-shielding sheet 810 in which conductive metal patterns made of copper (Cu) are formed in a mesh form.

FIG. 17 is an enlarged view of parts 820 and 830 of the external light-shielding sheet to which the EMI-shielding sheet according to the present invention, which is shown in FIG. 16, is adhered. As shown in FIG. 17, patterns 840 of the external light-shielding sheet are overlapped with first and second mesh patterns 850 and 860 of the EMI-shielding sheet.

When a dihedral angle θ₆ formed by the patterns 840 of the external light-shielding sheet and the first mesh pattern 850 of the EMI-shielding sheet is 20 to 60 degrees, the external light-shielding sheet to which the EMI-shielding sheet is adhered can have an EMI-shielding effect and also reduce a Moire effect.

In order for the external light-shielding sheet to shield external light incident from a top surface of a panel and effectively prevent a Moire effect, the dihedral angle θ₆ formed by the patterns 840 of the external light-shielding sheet and the first mesh pattern 850 of the EMI-shielding sheet may be in the range of 27 to 53 degrees.

Further, in order to facilitate the forming of the pattern and secure an appropriate aperture ratio and viewing angle of a plasma display apparatus, the dihedral angle θ₆ formed by the patterns 840 of the external light-shielding sheet and the first mesh pattern 850 of the EMI-shielding sheet may range from 40 to 50 degrees.

When a dihedral angle θ₇ formed by the patterns 840 of the external light-shielding sheet and the first mesh pattern 850 of the EMI-shielding sheet may range from 28 to 65 degrees, the external light-shielding sheet to which the EMI-shielding sheet is adhered can have an EMI-shielding effect and also reduce a Moire effect.

In order for the external light-shielding sheet to shield external light incident from the top surface of the panel and effectively prevent a Moire effect, the dihedral angle θ₇ formed by the patterns 840 of the external light-shielding sheet and the second mesh pattern 860 of the EMI-shielding sheet may be in the range of 33 to 58 degrees.

Further, in order to facilitate the forming of the pattern and secure an appropriate aperture ratio and viewing angle of a plasma display apparatus, the dihedral angle θ₇ formed by the patterns 840 of the external light-shielding sheet and the second mesh pattern 860 of the EMI-shielding sheet may range from 40 to 50 degrees.

The following Table 1 is the result of an experiment regarding whether a Moire effect occurs according to an angle of the patterns 840 of the external light-shielding sheet and the first and second mesh patterns 850 and 870 of the EMI-shielding sheet. In this experiment, a dihedral angle θ₁ of the patterns 840 of the external light-shielding sheet and a black matrix was fixed to an optimal value of 2.5 degrees and an angled in which the first and second mesh patterns 850 and 870 of the EMI-shielding sheet were formed was controlled.

In the following Table 1, “◯” refers to that the Moire effect occurred, “Δ” refers to that the Moire effect was reduced to 50% or less, and “x” refers to that the Moire effect was not generated.

TABLE 1

| θ₁ | θ₅ | θ₄ | Moire | θ₈ | θ₆ | θ₇ |
|---|---|---|---|---|---|---|
| 2.5 | 5 | 5 | ◯ | 170 | 2.5 | 7.5 |
| 2.5 | 5 | 7.5 | ◯ | 167.5 | 2.5 | 10 |
| 2.5 | 10 | 10 | ◯ | 160 | 7.5 | 12.5 |
| 2.5 | 10 | 12.5 | ◯ | 157.5 | 7.5 | 15 |
| 2.5 | 15 | 15 | ◯ | 150 | 12.5 | 17.5 |
| 2.5 | 15 | 17.5 | ◯ | 147.5 | 12.5 | 20 |
| 2.5 | 20 | 20 | ◯ | 140 | 17.5 | 22.5 |
| 2.5 | 20 | 22.5 | ◯ | 137.5 | 17.5 | 25 |
| 2.5 | 25 | 25 | ◯ | 130 | 22.5 | 27.5 |
| 2.5 | 25 | 27.5 | Δ | 127.5 | 22.5 | 30 |
| 2.5 | 30 | 30 | Δ | 120 | 27.5 | 32.5 |
| 2.5 | 30 | 32.5 | X | 117.5 | 27.5 | 35 |
| 2.5 | 35 | 35 | X | 110 | 32.5 | 37.5 |
| 2.5 | 35 | 37.5 | X | 107.5 | 32.5 | 40 |
| 2.5 | 40 | 40 | X | 100 | 37.5 | 42.5 |
| 2.5 | 40 | 42.5 | X | 97.5 | 37.5 | 45 |
| 2.5 | 45 | 45 | X | 90 | 42.5 | 47.5 |
| 2.5 | 45 | 47.5 | X | 87.5 | 42.5 | 50 |
| 2.5 | 50 | 50 | X | 80 | 47.5 | 52.5 |
| 2.5 | 50 | 52.5 | X | 77.5 | 47.5 | 55 |
| 2.5 | 55 | 55 | X | 70 | 52.5 | 57.5 |
| 2.5 | 55 | 57.5 | Δ | 67.5 | 52.5 | 60 |
| 2.5 | 60 | 60 | Δ | 60 | 57.5 | 62.5 |
| 2.5 | 60 | 62.5 | ◯ | 57.5 | 57.5 | 65 |
| 2.5 | 65 | 65 | ◯ | 50 | 62.5 | 67.5 |
| 2.5 | 65 | 67.5 | ◯ | 47.5 | 62.5 | 70 |
| 2.5 | 70 | 70 | ◯ | 40 | 67.5 | 72.5 |
| 2.5 | 70 | 72.5 | ◯ | 37.5 | 67.5 | 75 |
| 2.5 | 75 | 75 | ◯ | 30 | 72.5 | 77.5 |
| 2.5 | 75 | 77.5 | ◯ | 27.5 | 72.5 | 80 |
| 2.5 | 80 | 80 | ◯ | 20 | 77.5 | 82.5 |
| 2.5 | 80 | 82.5 | ◯ | 17.5 | 77.5 | 85 |
| 2.5 | 85 | 85 | ◯ | 10 | 82.5 | 87.5 |
| 2.5 | 85 | 87.5 | ◯ | 7.5 | 82.5 | 90 |
| 2.5 | 90 | 90 | ◯ | 0 | 87.5 | 92.5 |

From Table 1, it can be seen that when the dihedral angle θ₅ formed by the first mesh patterns 850 of the EMI-shielding layer and the black matrix is 25 to 60 degrees, the Moire effect can be reduced, and when the dihedral angle θ₅ is 30 to 55 degrees, the Moire effect can be prevented effectively. It can also be seen that when the dihedral angle θ₄ formed by the second mesh patterns 860 of the EMI-shielding layer and the black matrix is 27.5 to 60 degrees, the Moire effect can be reduced, and when the angle θ₄ is 32.5 to 55 degrees, the Moire effect can be prevented effectively.

It can be seen that when the dihedral angle θ₈ formed by the first mesh patterns 850 and the second mesh patterns 860 of the EMI-shielding layer is 60 to 127.5 degrees, the Moire effect can be reduced, and when the dihedral angle θ₈ is 70 to 117.5 degrees, the Moire effect can be prevented effectively.

When the dihedral angle θ₆ formed by the first mesh patterns 850 of the EMI-shielding layer and the patterns 840 of the external light-shielding sheet is 22.5 to 57.5 degrees, the Moire effect can be reduced, and when the dihedral angle θ₆ is 27.5 to 52.5 degrees, the Moire effect can be prevented effectively. In addition, when the dihedral angle θ₇ formed by the second mesh patterns 860 of the EMI-shielding layer and the patterns 840 of the external light-shielding sheet is 30 to 62.5 degrees, the Moire effect can be reduced, and when the dihedral angle θ₇ is 35 to 57.5 degrees, the Moire effect can be prevented effectively.

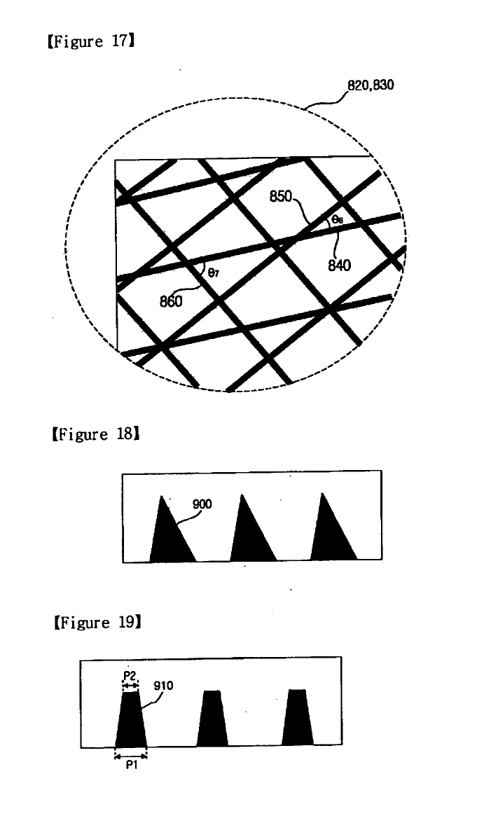

FIGS. 18 to 23 are cross-sectional views illustrating embodiments of the shape of a pattern unit of the external light-shielding sheet.

Referring to FIG. 18, a pattern unit 900 may have a symmetrical shape right and left. In other words, the pattern unit 900 may have the area of an inclined surface right and left. Further, an angle in which the right inclined surface and a bottom surface is formed may be different from an angle in which the left inclined surface and the bottom surface. Since objects that generate external light are generally placed over a panel, the external light is incident from an upper side of the panel to the panel within an angle range. Thus, in order to increase an external light absorption effect and increase the reflectance of light emitted from the panel, the slope of an inclined surface of the upper side on which the external light is incident, of two inclined surfaces of the pattern unit 900, may be gentler than that of the inclined surface of a lower side. In other words, the slope of the inclined surface of the upper side, of the two inclined surfaces of the pattern unit 900, may be set smaller than that of the inclined surface of the lower side.

Referring to FIG. 19, each pattern unit 910 may have a trapezoid. In this case, a width P2 of a top surface of the pattern unit 910 is smaller than a width P1 of a bottom surface of the pattern unit 910. The width P2 of the top surface of the pattern unit 910 may be set to 10 μm or less. Accordingly, in a relationship with the width P1 of the bottom surface, the slope of an inclined surface, which effectively obtains the absorption of an external light and the reflection of panel light, can be formed.

As shown in FIGS. 20 to 22, pattern units 920, 930, and 940 of an external light-shielding sheet may have a curved shape in which inclined surfaces on the right and left sides have a curvature. In this case, in order to improve an effect of shielding external light that is incident slantly, the amount of a change in the slopes of the inclined surfaces of the pattern units 920, 930, and 940 may decrease from a bottom surface to a top surface.

Further, in the embodiments with respect to the shapes of the pattern units shown in FIGS. 20 to 22, the pattern unit may have a curved shape in which a corner portion of the pattern unit has a curvature.

FIG. 23 is a cross-sectional view illustrating an embodiment with respect to a pattern unit of an external light-shielding sheet in which a bottom surface of the pattern unit is concave.

As shown in FIG. 23, a bottom surface 1015 of the pattern unit has a concave shape whose center is rounded and dug or depressed. Accordingly, a spreading phenomenon of an image, which occurs as light emitted from a panel is reflected from the bottom surface 1015 of the pattern unit, can be reduced. In the event that the external light-shielding sheet is adhered to other functional sheets or a panel, the area of an adhered portion can be increased and adhesive force can be improved accordingly. Further, since an incident angle of panel light incident on the bottom surface 1015 of the pattern unit is made small, absorptance of the panel light can be increased and a ghost phenomenon (that is, a spreading phenomenon of a display image) can be improved.

In other words, a pattern unit 1010 is formed in such a manner that the height at a central portion of the pattern unit 1010 is smaller than that at the outermost portion thereof. Accordingly, the pattern unit 1010 including the bottom surface 1015 having the concave shape can be formed.

The pattern unit 1010 can be formed by filling a groove, formed in the base unit 1000, with a light absorption material, etc. A part of the groove formed in the base unit 1000 can be filled with a light absorption material forming the pattern unit 1010, and the remaining portions thereof remain empty. Consequently, the bottom surface 1015 of the pattern unit may have a concave shape whose central portion is depressed inwardly.

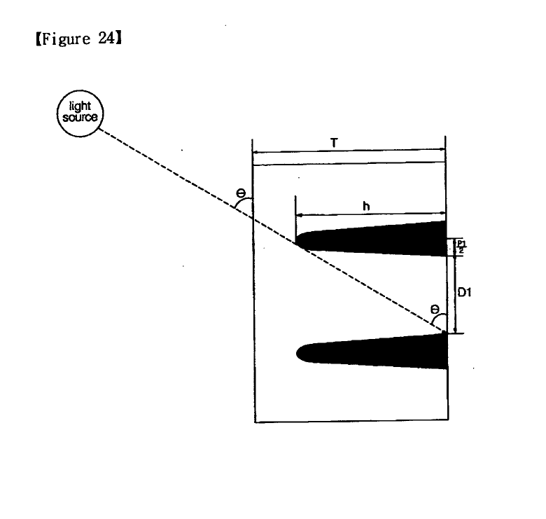

FIG. 24 is a cross-sectional view illustrating a relationship between the distance between neighboring pattern units formed in the external light-shielding sheet and the height of the pattern unit.

Referring to FIG. 24, in order to secure the robustness of the external light-shielding sheet including the pattern units and also secure the transmittance of a visible ray emitted from a panel so as to display an image, the external light-shielding sheet may have a thickness T of 100 μm to 180 μm.

When a height h of the pattern unit included in the external light-shielding sheet is 80 to 170 μm, fabrication of the pattern unit can be most convenient, the external light-shielding sheet can have an adequate aperture ratio, and an external light-shielding effect and an effect of reflecting light emitted from the panel can be maximized.

The height h of the pattern unit may vary depending on the thickness T of the external light-shielding sheet. External light, which is incident on the panel and affects a lowering in bright room contrast, is generally placed over the panel. Accordingly, in order to effectively shield external light incident on the panel at an incident angle θ of a predetermined range, the ratio of the height h of the pattern unit and the thickness T of the external light-shielding sheet may have a predetermined value range.

As the height h of the pattern unit increases, the thickness of a base unit at the top of the pattern unit becomes thin, resulting in insulating breakdown. As the height h of the pattern unit decreases, external light within a predetermined angle range is incident on the panel, so that the external light may not be properly shielded.

The following Table 2 is the result of an experiment on insulating breakdown and an external light-shielding effect of the external light-shielding sheet according to the thickness T of the external light-shielding sheet and the height h of the pattern unit.

TABLE 2

| | Height h of pattern | Insulating | External light |
|---|---|---|---|
| Sheet thickness T | unit | breakdown | shielded |
| 120 μm | 120 μm | ∘ | ∘ |
| 120 μm | 115 μm | Δ | ∘ |
| 120 μm | 110 μm | x | ∘ |
| 120 μm | 105 μm | x | ∘ |
| 120 μm | 100 μm | x | ∘ |
| 120 μm | 95 μm | x | ∘ |
| 120 μm | 90 μm | x | ∘ |
| 120 μm | 85 μm | x | Δ |
| 120 μm | 80 μm | x | Δ |
| 120 μm | 75 μm | x | Δ |
| 120 μm | 70 μm | x | Δ |
| 120 μm | 65 μm | x | Δ |
| 120 μm | 60 μm | x | Δ |
| 120 μm | 55 μm | x | Δ |
| 120 μm | 50 μm | x | x |

Referring to Table 2, in the event that the thickness T of the external light-shielding sheet is 120 μm, when the height h of the pattern unit is 115 μm or more, the failure rate of products may increase because there is a danger that the pattern unit may experience insulating breakdown. When the height h of the pattern unit is 115 μm or less, the failure rate of the external light-shielding sheet can decrease because there is no danger that the pattern unit may experience insulating breakdown. However, when the height of the pattern unit is 85 μm or less, an efficiency in which external light is shielded by the pattern unit may decrease. When the height of the pattern unit is 60 μm or less, external light can be incident on the panel. Accordingly, when the height h of the pattern unit ranges from 90 μm to 110 μm, external light-shielding efficiency of the external light-shielding sheet can be increased and the failure rate can be decreased.

Further, when the thickness T of the external light-shielding sheet is 1.01 to 2.25 times greater than the height h of the pattern unit, insulating breakdown at the top of the pattern unit can be prevented and external light can be prevented from being incident on the panel. Further, in order to prevent insulating breakdown and external light being incident on the panel, increase the reflectance of light emitted from the panel, and secure a viewing angle, the thickness T of the external light-shielding sheet may be 1.01 to 1.5 times greater than the height h of the pattern unit.

The following Table 3 is the result of an experiment on whether the Moire effect occurred or and an external light-shielding effect according to the ratio of a width at the bottom surface of the pattern unit of the external light-shielding sheet and a width of the bus electrode formed in the front substrate of the panel. It was assumed that the width of the bus electrode was 70 μm.

TABLE 3

| Width of bottom surface of pattern | | External light |
|---|---|---|
| unit/width of bus electrode | Moire effect | shielded |
| 0.10 | Δ | x |
| 0.15 | Δ | x |
| 0.20 | x | Δ |
| 0.25 | x | ∘ |
| 0.30 | x | ∘ |
| 0.35 | x | ∘ |
| 0.40 | x | ∘ |
| 0.45 | Δ | ∘ |
| 0.50 | Δ | ∘ |
| 0.55 | ∘ | ∘ |
| 0.60 | ∘ | ∘ |

From Table 3, it can be seen that the width of the bottom surface of the pattern unit is 0.2 to 0.5 times greater than that of the bus electrode, a Moire effect can be reduced and external light, being incident on the panel, can also be reduced. In order to prevent a Moire effect, effectively shield external light, and also secure an aperture ratio for discharging panel light, the width of the bottom surface of the pattern unit may be 0.25 to 0.4 times greater than that of the bus electrode.

The following Table 4 is the result of an experiment on whether the Moire effect occurred and an external light-shielding effect according to the ratio of the width of the bottom surface of the pattern unit of the external light-shielding sheet and the width of the longitudinal barrier rib formed in the rear substrate of the panel. In this case, it was assumed that the width of the longitudinal barrier rib was 50 μm.

TABLE 4

| Width of bottom surface of pattern | | |
|---|---|---|
| unit/width of top surface of lon- | | |
| gitudinal barrier | Moire effect | Moire effect |
| 0.10 | ∘ | x |
| 0.15 | Δ | x |
| 0.20 | Δ | x |
| 0.25 | Δ | x |
| 0.30 | x | Δ |
| 0.35 | x | Δ |
| 0.40 | x | ∘ |
| 0.45 | x | ∘ |
| 0.50 | x | ∘ |
| 0.55 | x | ∘ |
| 0.60 | x | ∘ |
| 0.65 | x | ∘ |
| 0.70 | Δ | ∘ |
| 0.75 | Δ | ∘ |
| 0.80 | Δ | ∘ |
| 0.85 | ∘ | ∘ |
| 0.90 | ∘ | ∘ |

From Table 4, it can be seen that when the width of the bottom surface of the pattern unit is 0.3 to 0.8 times greater than the width of the top surface of the longitudinal barrier rib, the Moire effect can be reduced and external light, being incident on the panel, can also be reduced. In order to prevent the Moire effect, effectively shield external light, and also secure an aperture ratio for discharging panel light, the width of the bottom surface of the pattern unit may be 0.4 to 0.65 times greater than that of the top surface of the longitudinal barrier rib.

### INDUSTRIAL APPLICABILITY

It has been described above that the filter according to the present invention is disposed on the front surface of the plasma display panel. However, the filter according to the present invention may be used for several display apparatus, such as liquid crystal display (LCD) and organic light emitting diode (OLED), as well as the plasma display apparatus.

As described above, in the plasma display apparatus according to the present invention, the external light-shielding sheet capable of absorbing and shielding externally incident light to the greatest extent is adhered on the front surface of the panel. Accordingly, a black image can be implemented effectively and bright room contrast can be improved. Further, since a bias angle of the pattern unit of the external light-shielding sheet can be controlled easily, a Moire effect can be reduced effectively. In addition, since the external light-shielding sheet is disposed adjacent to the panel, a ghost phenomenon can be improved.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A plasma display apparatus, comprising:
a plasma display panel;
a filter disposed on a front surface of the panel and comprising at least one of an anti-reflection (AR) layer, a near infrared (NIR)-shielding layer, and an electromagnetic interference (EMI)-shielding layer; and
an external light-shielding sheet disposed on the front surface of the panel, and
comprising a base unit and a plurality of pattern units formed in the base unit,
wherein the filter and the external light-shielding sheet are adhered to the panel or fixed to a supporter, and
an air layer exists between the external light-shielding sheet and the filter.

2. The plasma display apparatus of claim 1, wherein a dihedral angle formed by electrodes formed in a front substrate of the panel and the pattern units of the external light-shielding sheet is in the range of 0.5 to 9 degrees.

3. The plasma display apparatus of claim 1, wherein a dihedral angle formed by electrodes formed in a front substrate of the panel and the pattern units of the external light-shielding sheet is in the range of 0.5 to 4.5 degrees.

4. The plasma display apparatus of claim 1, wherein:
each pattern unit has a refractive index higher than that of the base unit, and
a difference in the refractive index between the base unit and the pattern unit is 0.05 to 0.3.

5. The plasma display apparatus of claim 1, wherein a refractive index of the pattern unit is 1.0 to 1.3 times greater than that of the base unit.

6. The plasma display apparatus of claim 1, wherein a refractive index of the pattern unit is 0.3 to 1 times less than that of the base unit.

7. The plasma display apparatus of claim 1, wherein a top surface of the pattern unit is disposed closer to the panel than a bottom surface of the pattern unit, which has a width larger than that of the top surface.

8. The plasma display apparatus of claim 1, wherein a thickness of the external light-shielding sheet is 1.01 to 2.25 times greater than a height of the pattern unit.

9. The plasma display apparatus of claim 1, wherein a distance between bottom surfaces of neighboring two of the plurality of pattern units is 1.1 to 5 times greater than a width of a bottom surface of the pattern unit.

10. The plasma display apparatus of claim 1, wherein a height of the pattern unit is 1.5 to 3 times greater than a distance of bottom surfaces of neighboring two of the plurality of pattern units.

11. The plasma display apparatus of claim 1, wherein a distance between top surfaces of neighboring two of the plurality of pattern units is 1 to 3.25 times greater than a distance between bottom surfaces of neighboring two of the plurality of pattern units.

12. The plasma display apparatus of claim 1, wherein a dihedral angle formed by any one of metal patterns formed in the EMI-shielding layer and any one of the plurality of pattern units is within a range of 27.5 to 52.5 degrees.

13. A plasma display apparatus comprising:
a plasma display panel;
a filter comprising at least one of an AR layer, a NIR-shielding layer, and an EMI-shielding layer; and
an external light-shielding sheet comprising a base unit and a plurality of pattern units formed in the base unit,
wherein the external light-shielding sheet is adhered to a front surface of the panel, the filter is spaced apart from the panel and fixed to a supporter disposed on the front surface of the panel, and an air layer exists between the external light-shielding sheet and the filter.

14. The plasma display apparatus of claim 13, wherein at least one of the AR layer, the NIR-shielding layer, and the EMI-shielding layer is adhered to glass.

15. The plasma display apparatus of claim 13, wherein an adhesive layer is formed between the external light-shielding sheet and the panel.

16. The plasma display apparatus of claim 13, wherein a distance between the filter and the panel is in the range of 1.1 mm to 3.2 mm.

17. The plasma display apparatus of claim 13, wherein a dihedral angle formed by electrodes formed in a front substrate of the panel and the pattern units of the external light-shielding sheet is in the range of 0.5 to 9 degrees.

18. The plasma display apparatus of claim 13, wherein:
each pattern unit has a refractive index higher than that of the base unit, and a difference in the refractive index between the base unit and the pattern unit is 0.05 to 0.3.

19. The plasma display apparatus of claim 13, wherein a refractive index of the pattern unit is 0.3 to 1 times less than that of the base unit.

20. The plasma display apparatus of claim 13, wherein a thickness of the external light-shielding sheet is 1.01 to 2.25 times greater than a height of the pattern unit.
